(19) United States
(12) Patent Application Publication
(10) Pub. No.: US 2006/0267959 A1
(43) Pub. Date: Nov. 30, 2006

(54) MAP DISPLAY SYSTEM

(75) Inventors: Takaomi Goto, Kobe-shi (JP); Shinsuke Tomiyoshi, Kobe-shi (JP)

Correspondence Address: FOGG AND ASSOCIATES, LLC, P.O. BOX 581339, MINNEAPOLIS, MN, 55458-1339, US

(73) Assignee: FUJITSU TEN LIMITED, Kobe-shi (JP)

(21) Appl. No.: 11/421,238

(22) Filed: May 31, 2006

(30) Foreign Application Priority Data
May 31, 2005 (JP) 2005-159237
Apr. 20, 2006 (JP) 2006-116731

(51) Int. Cl. G09G 5/00

(52) U.S. Cl. 345/173

(57) ABSTRACT

When an operator touches a touch panel momentarily for a very short time or when an operator scrolls a finger placed on the touch panel, input error is reduced. A map display system is comprised of a display device able to display a map on a screen, a touch panel circuit able to detect a touch operation on the screen in a predetermined detection cycle, a microcomputer changing the detection cycle of the touch panel so that after a touch operation to the screen is detected in a first cycle, a touch operation to the screen is detected in a second cycle longer than the first cycle, and a control circuit scrolling the map displayed on the display device in accordance with the detection result of the touch operation by the touch panel.

### CROSS-REFERENCE TO RELATED APPLICATIONS

This application claims priority from and incorporates by reference the entire disclosure of Japanese Patent Application No. 2005-159237, filed on May 31, 2005, and Japanese Patent Application No. 2006-116731, filed on Apr. 20, 2006.

### BACKGROUND OF THE INVENTION

1. Field of the Invention

The present invention relates to a map display system and map display method, more particularly relates to a map display system and map display method in a car navigation system able to display a map on a screen which reliably detect both a momentary touch and a continuous touch on the screen and able to scroll the map on the screen.

2. Description of the Related Art

In the past, in electronic apparatuses provided with display devices, for example, personal computers, electronic copiers, printers, facsimile devices, video cameras, etc., in order to reduce the number of switches provided on the housings of the electronic apparatuses and thereby reduce the size, the screens of the display devices themselves are being given switch functions. As such a screen switch, a position display device enabling a coordinate position on the screen to be input (also known as a “pointing device” or “image position display device”) has been used.

As a typical position display device, there is a touch panel using a touch screen. A touch panel is provided overlaid on the screen of the display device and detects coordinates on the screen which are touched. The screen is usually touched by the finger, but sometimes a pen or other tool is used to touch the screen. Such a touch panel displays switches on the display device. When touching the part of the touch panel over a switch, the switch is turned on/off in a general method of use.

On the other hand, when drawing a graphic on the screen of a display device of a personal computer, when setting a route on a display device of a car navigation system, when scrolling a map on a screen, etc., a touch switch showing the scrolling direction on the touch panel is touched or a position offset from the center of the touch panel in the direction to be scrolled is touched in a touch operation.

As such a touch panel, an analog (resistance type) touch panel supplying DC current to the two ends of a resistance film is generally used. Further, there is an analog electrostatic capacity type. In an analog resistance type touch panel, the potential of the touched position can be detected to calculate a coordinate position on a high resolution touch panel. Further, a digital (optical type) touch panel comprised of light receiving/emitting elements forming a matrix like sensor region is also known.

However, in an analog type touch panel, touch of the panel is detected by cyclically detecting the voltage at the two ends of the resistance film to detect if the panel has been touched, but if two points on the panel are touched, they cannot be discriminated and there is the possibility of a touched position being mistakenly detected. Therefore, performing interruption processing in a second cycle shorter than the first cycle when it is necessary to detect a touched state of the panel in the first cycle and detect and confirm the coordinates is described in Japanese Patent Publication (A) No. 2000-47806.

Further, in such a touch panel, regardless of whether the touch panel is touched, touch of the touch panel is constantly detected by a constant detection cycle, so the power consumption is large. Therefore, lengthening the detection cycle to reduce the power consumption when there is no continuous input operation to the touch panel is described in Japanese Patent Publication (A) No. 9-152932.

However, in the touch panel detecting the touch state of the panel in the first cycle disclosed in Japanese Patent Publication (A) No. 2000-47806 and in the touch panel detecting touch to the touch panel constantly by a constant detection cycle disclosed in Japanese Patent Publication (A) No. 9-152932, when the operator touches the touch panel momentarily by a very slight time, there is the problem that this touch cannot be detected when the moment is the time between detection cycles. The above-mentioned digital touch panel has the same problems.

As opposed to this, it may be considered to greatly shorten the detection cycle of the state of touch to the touch panel, but if setting the detection cycle of the state of touch to the touch panel short, if, like in a car navigation system, the operator continuously touches the touch panel in the operation (map scroll operation), the detection timing would be too fast, so the scrolling would become rapid and sometimes it would be detected as double touching of the screen. The problem would therefore arise of the operator feeling like there was an input error.

That is, for example, when the amount of scrolling of the map per touch detection (unit dot/touch detection) is preset, if the touch detection cycle is extremely short, the number of times of detection of touch in a predetermined time would become greater and the amount of scrolling while the touch panel continues being touched will end up becoming greater. Due to this, the operator will feel as if the scrolling of the map became faster.

Further, even when the operator momentarily touches the touch panel (when the operator recognizes the touch as being single), if the detection cycle of the touch state is extremely short, it would be detected that the operator double touched the screen. Due to this, there was the problem of the operator feeling as if there was an input error.

### SUMMARY OF THE INVENTION

Therefore, an object of the present invention is to provide a map display system and map display method in a system provided with a touch panel and able to display a map on a display screen such as a car navigation system wherein even when the operator touches the touch panel for an extremely short time or when the operator continuously touches the touch panel, no input error is caused.

To achieve the above object, according to a first aspect of the present invention, there is provided a map display device comprising a display displaying a map on a screen, a touch detection circuit detecting a touch operation on the screen in a predetermined detection cycle, a display control circuit scrolling the map displayed on the screen in response to the detection circuit, and a detection cycle changing circuit changing the predetermined detection cycle from a first cycle to a second cycle when the touch operation is detected in a first cycle, wherein the second cycle is longer than the first cycle.

Further, to achieve the above object, there is provided a map display method comprising displaying a map on a screen, detecting a touch operation to the screen in a first cycle, changing the detection cycle from the first cycle to a second cycle when the touch operation is detected in the first cycle, wherein the second cycle is longer than the first cycle, detecting a touch operation to the screen in the second cycle, and controlling the scrolling of the map displayed on the screen in response to the touch operation.

According to the map display system and map display method of the present invention, there are the effects that even when the operator touches the touch panel for an extremely short time, touch to the touch panel can be continuously detected and that even when the operator continuously touches the touch panel in a scrolling operation, no input error occurs.

### BRIEF DESCRIPTION OF THE DRAWINGS

The present invention is illustrated by way of example, and not limitation, in the figures of the accompanying drawings in which like references indicate similar elements. Note that the following figures are not necessarily drawn to scale. In this figures,

FIG. 1 is a view of the configuration of a navigation system provided with a touch panel as one example of map display of the present invention;

FIG. 2 is a circuit diagram showing the circuit configuration when detecting a touch of the touch panel shown in FIG. 1;

FIG. 3 is a time chart showing an embodiment of the present invention and explaining a change of the touch detection cycle in FIG. 2;

FIG. 4A is a circuit diagram showing the circuit configuration when detecting an X-coordinate in the touch panel shown in FIG. 1;

FIG. 4B is an explanatory view showing a position on a touch panel detected by the circuit of FIG. 4A;

FIG. 5A is a circuit diagram showing the circuit configuration when detecting a Y-coordinate in a touch panel shown in FIG. 1;

FIG. 5B is an explanatory view showing the position on a touch panel detected by the circuit of FIG. 5A;

FIG. 6 is a time chart for explaining the coordinate acquisition timing when detecting the X-, Y-coordinates of a touched point on the touch panel in the circuit shown in FIG. 4A and FIG. 5B;

FIG. 7 is a flow chart of an embodiment of a processing routine for detection of the existence of touch of a touch panel in the present invention;

FIG. 8A is a flow chart of an embodiment of a processing routine for detection of an X-coordinate of a position touched on a touch panel in the present invention;

FIG. 8B is a flow chart of an embodiment of a routine for preparation of detection of an Y-coordinate of a position touched on a touch panel in the present invention;

FIG. 9 is a flow chart of an embodiment of a routine for calculation of X-, Y-coordinates of a position touched on a touch panel in the present invention;

FIG. 10A is a flow chart showing details of step 902 of FIG. 9;

FIG. 10B is a flow chart showing details of step 904 of FIG. 9;

FIG. 11 is a perspective view showing an example of mounting of a navigation system provided with a touch panel according to the present invention in a vehicle;

FIG. 12 is a flow chart showing an example of the processing for scrolling in a navigation system provided with a touch panel of the present invention;

FIG. 13A is an explanatory view for explaining an example of scrolling so that a touched position on a display device matches with the center of the screen of the display device and shows a location touched on a map on a screen;

FIG. 13B is an explanatory view for explaining an example of scrolling so that a touched position on a display device matches with the center of the screen of the display device and shows the state of a touched point on a map shown in FIG. 13A being scrolled and moving to the center of the display device; and

FIG. 14 is an explanatory view of an example of screen division for scrolling of a map in accordance with a touched position set on a display screen of a display device.

### DESCRIPTION OF THE PREFERRED EMBODIMENTS

Below, preferred embodiments of the present invention will be explained with reference to the attached drawings.

Note that in the embodiments explained below, an analog resistance type touch panel will be explained, but the present invention may of course also be applied to an analog electrostatic capacity type touch panel or a digital optical type touch panel comprised of light receiving/emitting elements formed in a matrix.

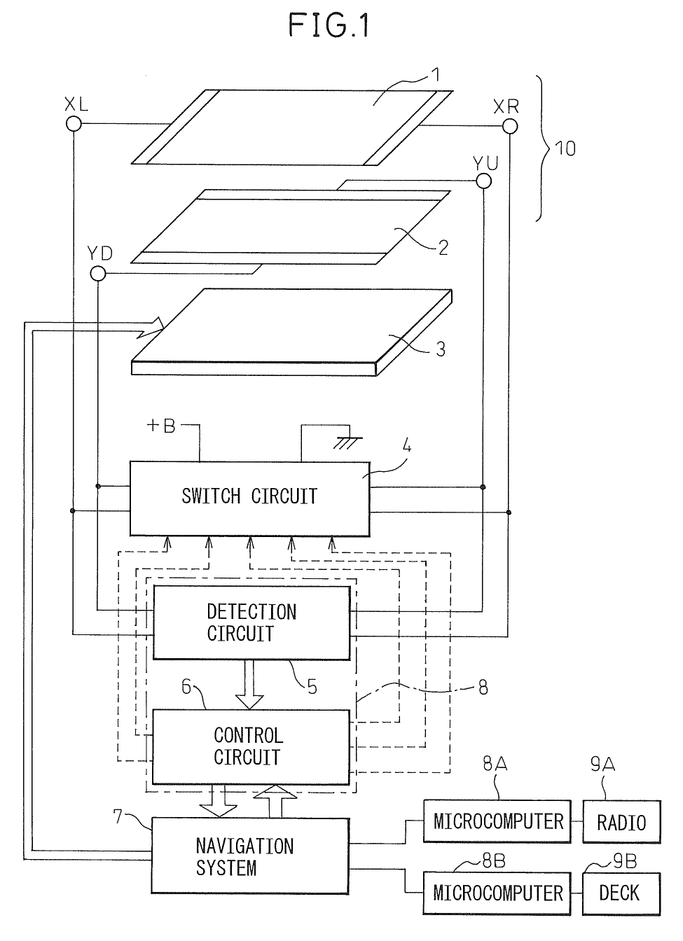

FIG. 1 shows the configuration of a navigation system 7 provided with a touch panel 10 of an example of a map display system of the present invention. The touch panel 10 is comprised of an X-side resistance film 1 having a pair of X-electrode terminals XL, XR and an Y-side resistance film 2 having a pair of Y-electrode terminals YD, YU arranged facing each other across a predetermined interval. At the back of this touch panel 10 is arranged a display device 3 using a liquid crystal display panel for displaying an image.

The four electrode terminals XL, XR, YD, YU of the touch panel 10 are connected to a switch circuit 4 able to supply either a touch detection signal or coordinate detection signal between any two electrode terminals of these electrode terminals. The switch circuit 4 has a plurality of switches built into it. This configuration will be explained later.

Further, the circuits connecting the switch circuit 4 and the four electrode terminals XL, XR, YD, YU of the touch panel 10 are all branched and connected to a detection circuit 5. The detection circuit 5 uses the voltage values detected from across the electrode terminals of the touch panel 10 to detect a touch on the touch panel 10 or detect the coordinates of a touched position of the touch panel 10 when any of a touch detection signal or coordinate detection signal is supplied to two electrode terminals of the four electrode terminals XL, XR, YD, YU of the touch panel 10 through the switch circuit 4. The existence of touch or touch coordinates detected by the detection circuit 5 is input to the control circuit 6.

The control circuit 6 controls the switches in the switch circuit 4 on/off based on the signals input from the detection circuit 5 and transfers signals input from the detection circuit 5 with the navigation system 7. The control circuit 6 receives instructions from the navigation system 7. The detection circuit 5 and the control circuit 6 can be built into a single microcomputer 8.

This navigation system 7 can send an image to the display device 3 to make the display device display map information or video information. For example, the navigation system 7 controls the map displayed on the display device 3 to be scrolled based on a signal relating to the detection of the touch state of the touch panel 10 or the touched position coordinates from the detection circuit 5 received from the control circuit 6.

Further, the navigation system 7 is connected to not only the microcomputer 8 for controlling the touch panel 10, but also a microcomputer 8A for controlling a radio 9A, a microcomputer 8B for controlling a deck 9B driving a tape or disk, etc. The navigation system 7 is also connected to an antenna, speaker, etc., but these configurations are not the main gist of the present invention, so their explanations will be omitted here. Further, an example of mounting the navigation system 7 in a vehicle will be explained later.

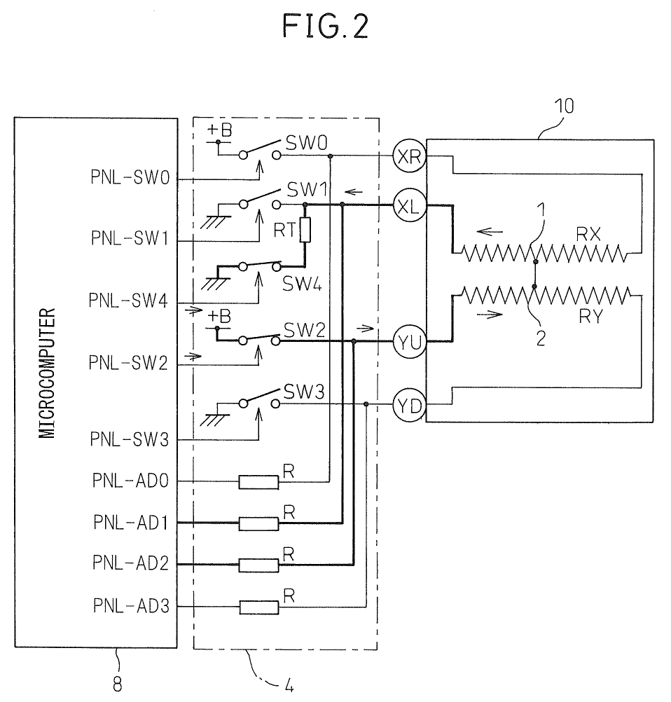

FIG. 2 is a circuit diagram showing the circuit configuration for detecting if the touch panel 10 shown in FIG. 1 has been touched. This figure shows the resistance value of the X-side resistance film 1 shown in FIG. 1 by the resistance RX and shows the resistance value of the Y-side resistance film 2 by the resistance RY. Further, the detection circuit 5 and control circuit 6 shown in FIG. 1 are shown as a single microcomputer 8.

The switch circuit 4, in this embodiment, includes the five switches SW0 to SW4 and a resistor RT, the four resistors R, and another resistor RT. The switch SW0 is connected between the 5V or so direct current power source +B and the X-electrode terminal XR of the touch panel 10 is turned on by an ON signal from the output terminal PNL-SW0 of the microcomputer 8. The switch SW1 is connected between the ground and the X-electrode terminal XL of the touch panel 10 and is turned on by the ON signal from the output terminal PNL-SW1 of the microcomputer 8.

The switch SW2 is connected between the 5V or so direct current power source +B and the Y-electrode terminal YU of the touch panel 10 and is turned on by the ON signal from the output terminal PNL-SW2 of the microcomputer 8. The switch SW3 is connected between the ground and the Y-electrode terminal YD of the touch panel 10 and is turned on by the ON signal from the output terminal PNL-SW3 of the microcomputer 8.

On the other hand, the other switch SW4 is connected through the resistor RT between the ground and the X-electrode terminal XL of the touch panel 10. The switch SW4 is turned on by the ON signal from the output terminal PNL-SW4 of the microcomputer 8.

Further, circuits provided with resistors R are provided between the X-electrode terminals XR, XL and Y-electrode terminals YU, YD of the touch panel 10 and the input terminals PNL-AD0 to PNL-AD3 of the microcomputer 8. These four circuits can detect the voltages generated at the X-electrode terminals XR, XL or Y-electrode terminals YU, YD of the touch panel 10 at the microcomputer 8 side. Note that the four resistors R do not have to be the same in resistance value.

When the thus configured switch circuit 4 is used to detect if the touch panel 10 has been touched, as shown in FIG. 2, ON signals are output from the output terminal PNL-SW2 and the output terminal PNL-SW4 of the microcomputer 8. This being so, only the switches SW2 and SW4 turn on and the other switches are off.

In the state where only the switches SW2 and SW4 are in the on state, the microcomputer 8 uses the input PNL-AD1 and PNL-AD2 to detect the potential difference between the X-electrode terminal XL and the Y-electrode terminal YU. When the touch panel 10 has not been touched, the X-side resistance film RX to which the voltage is applied and the grounded Y-side resistance film RY are not in contact, so the potential difference between the X-electrode terminal XL and the Y-electrode terminal YU is equal to the potential of the direct current power source +B.

On the other hand, when the touch panel 10 is touched, the X-side resistance film RX to which the voltage is applied and the grounded Y-side resistance film RY are in contact, so current flows from the direct current power source +B toward the ground by the path shown by the bold lines and arrows. As a result, the potential of the X-electrode terminal XL rises. At this time, if the resistance value of the resistor RT is made larger than the resistance values RX, RY of the resistance films 1, 2 of the touch panel 10, the potential of the X-electrode terminal XL rises and approaches the potential at the Y-electrode terminal YU, so the difference between the two becomes very small (almost 0).

Accordingly, the microcomputer 8 can detect that the touch panel 10 has not been touched when the potential between the input terminals PNL-AD1 and PNL-AD2 is the power source potential and that the touch panel 10 has been touched when the potential between the input terminals PNL-AD1 and PNL-AD2 is 0. Further, in a conventional touch panel, the timing at which this switch SW4 turns on, that is, the timing at which an ON signal is output from the output terminal PNL-SW4 of the microcomputer 8, was constant. This ON signal is usually a pulse signal. The pulse width is about 2 ms.

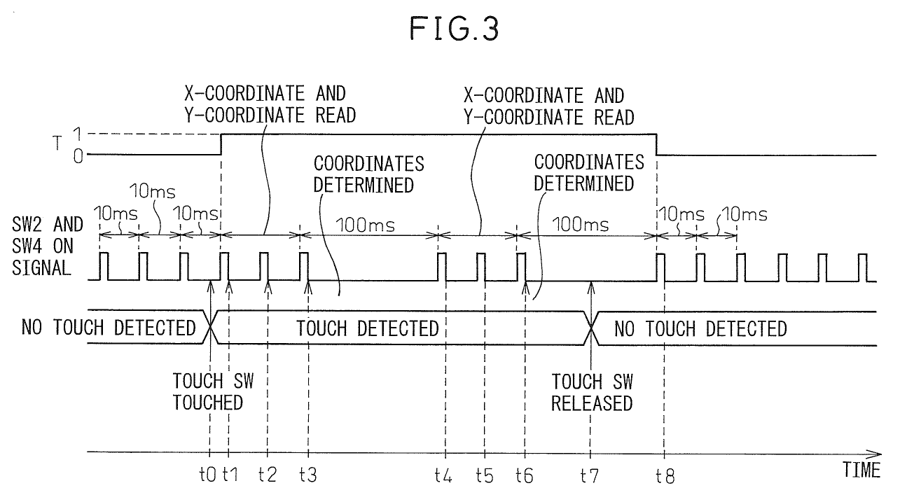

Therefore, in the present invention, the control circuit 6 shown in FIG. 1 makes the timing of the pulse like ON signal output from the output terminal PNL-SW4 of the microcomputer 8 a short cycle of every 10 ms when the touch panel 10 is not touched and changes it to a long cycle of every 100 ms when the touch panel 10 is touched. Further, when the touch on the touch panel 10 is released, the timing of the ON signal output from the output terminal PNL-SW4 of the microcomputer 8 is returned to a short cycle of every 10 ms. This will be explained in detail using FIG. 3.

As shown before the time t0 of the FIG. 3, when the touch panel 10 is not touched, the timing of the ON signal output from the output terminal PNL-SW4 of the microcomputer 8 becomes a short cycle of every 10 ms. Further, when the touch panel 10 is touched at the time t0, this touch is detected by the next ON signal at the time t1 and the touch detection signal T becomes “1”. Right after the touch detection signal T becomes “1”, the timing of the ON signal output from the output terminal PNL-SW4 of the microcomputer 8 may be increased to 100 ms, but in this embodiment, an ON signal is output from the output terminal PNL-SW4 of the microcomputer 8 by a short cycle of every 10 ms up until the time t3.

This is because in this embodiment, the X-coordinate in the coordinates of the touched position on the touch panel is calculated in the 10 ms of time from the time t1 to the time t2, while the Y-, X-coordinates in the coordinates of the touched position on the touch panel are calculated in the 10 ms of time from the time t2 to the time t3. Further, if the state of the touch detection signal T being “1” continues, after the X-, Y-coordinates of the touched position on the touch panel 10 are calculated, the timing until the ON signal output from the output terminal PNL-SW4 of the microcomputer 8 is made 100 ms. Note that the two ON signals falling at the times t2 and t3 are for detecting the touch to the touch panel at these times.

Further, in this embodiment, after an interval of 100 ms, the next ON signal is output from the output terminal PNL-SW4 of the microcomputer 8. Right after this, two ON signals are output from the output terminal PNL-SW4 of the microcomputer 8 every 10 ms. Further, in the 10 ms between a first signal and second signal among three consecutive ON signals (between the time t4 and time t5) and the 10 ms between the second signal and third signal (between the time t5 and time t6), the Y-, X-coordinates in the coordinates of the touched position on the touch panel are calculated. The operation is repeated while the touch detection signal T continues in the “1” state.

On the other hand, when the touch panel 10 is no longer touched at the time t7, 100 ms from the rising edge of the pulse of the ON signal falling at the time t6, it is detected that the touch panel 10 is no longer touched by the ON signal output from the output terminal PNL-SW4 of the microcomputer 8. This being the case, the touch detection signal T becomes “0”. After the time t8 at which this ON signal falls, an ON signal is output from the output terminal PNL-SW4 of the microcomputer 8 every 10 ms.

However, in general, the time required for an operator to momentarily touch the touch panel is 20 to 30 ms. Therefore, like in this embodiment, if an ON signal, that is, touch detection signal, is output from the output terminal PNL-SW4 of the microcomputer 8 at intervals of 10 ms, a touch of the operator on the touch panel 10 can be reliably detected.

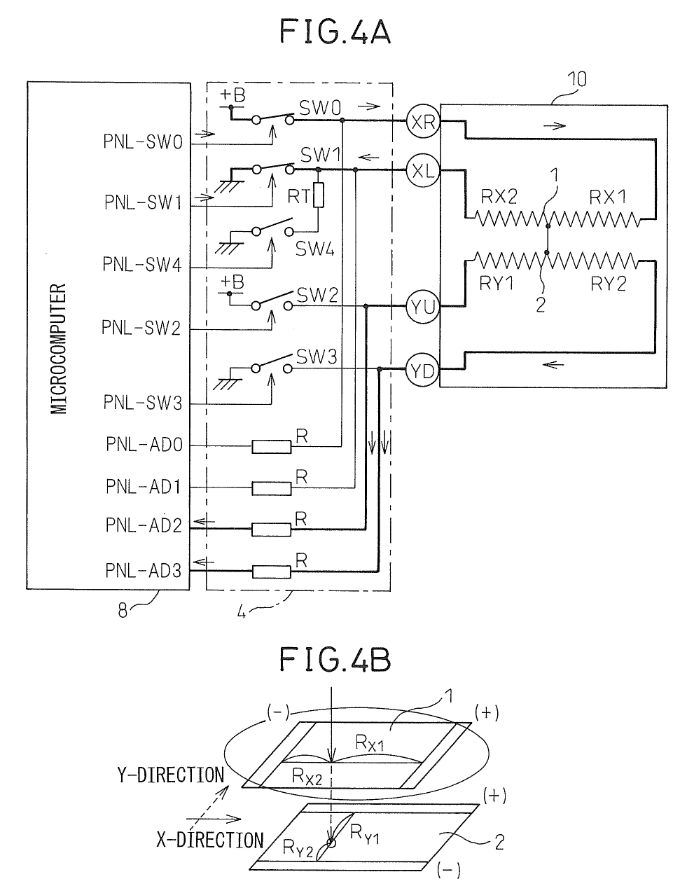

FIG. 4A is a circuit diagram showing the state of the switches of the switch circuit 4 when detecting the X-coordinate of a touched point in the touch panel 10 shown in FIG. 1, while FIG. 4B is an explanatory view showing the coordinate position in the X-direction on the touch panel 10 detected by the circuit of FIG. 4A. When detecting the X-coordinate of the touched point of the touch panel 10, as shown in FIG. 4A, ON signals are output from the output terminal PNL-SW0 and the output terminal PNL-SW1 of the microcomputer 8. This being the case, only the switches SW0 and SW1 turn on. The other switches are off.

In this state, current flows to the touch panel 10 as shown by the bold lines and arrows. As shown in FIG. 4B, voltage is generated from the touched point of the X-side resistance film 1 in accordance with the ratio of the resistance value RX1 of the power source side (+) and resistance value RX2 of the ground side (−). This voltage is input from the touched point of the Y-side resistance film 2 through the resistance value RY1 of the power source side and the resistance value RY2 of the ground side to the input terminals PNL-AD2 and PNL-AD3 of the microcomputer 8, so the microcomputer 8 can detect the X-coordinate of the touched point based on this input voltage.

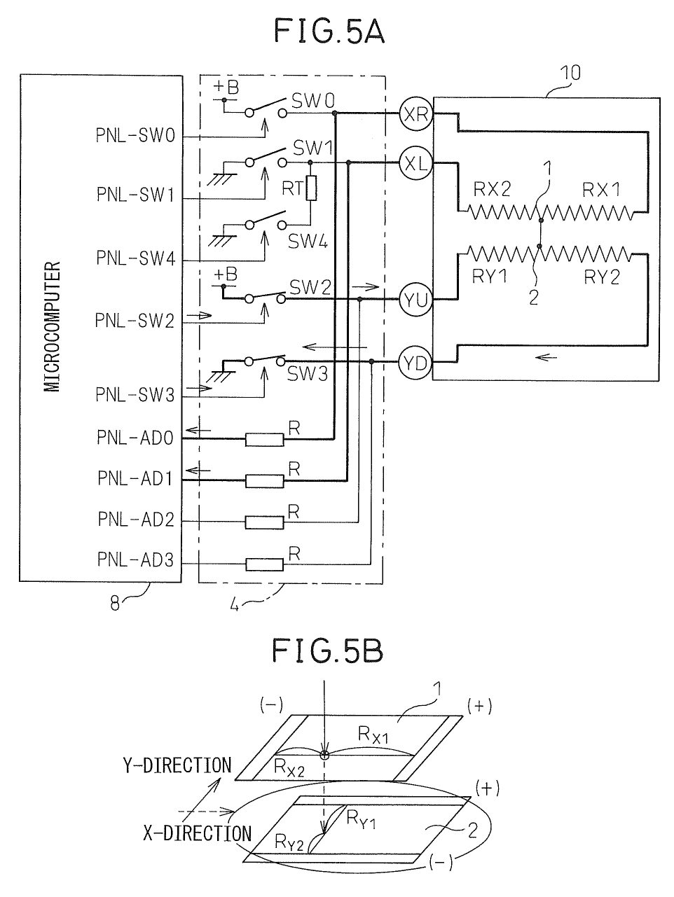

FIG. 5A is a circuit diagram showing the state of the switches of the switch circuit 4 when detecting a Y-coordinate of a touched point when the touch panel 10 shown in FIG. 1 is touched, while FIG. 5B is an explanatory view showing the coordinate position in the X-direction on the touch panel 10 detected by the circuit of FIG. 5A. When detecting the X-coordinate of the touched point of the touch panel 10, as shown in FIG. 5A, ON signals are output from the output terminal PNL-SW2 and the output terminal PNL-SW3 of the microcomputer 8. This being the case, only the switches SW2 and SW3 turn on. The other switches are off.

In this state, current flows to the touch panel 10 as shown by the bold lines and arrows. As shown in FIG. 5B, voltage is generated from the touched point of the Y-side resistance film 2 in accordance with the ratio of the resistance value RY1 of the power source side (+) and resistance value RY2 of the ground side (−). This voltage is input from the touched point of the X-side resistance film 1 through the resistance value RX1 of the power source side and the resistance value RX2 of the ground side to the input terminals PNL-AD0 and PNL-AD1 of the microcomputer 8, so the microcomputer 8 can detect the X-coordinate of the touched point based on this input voltage.

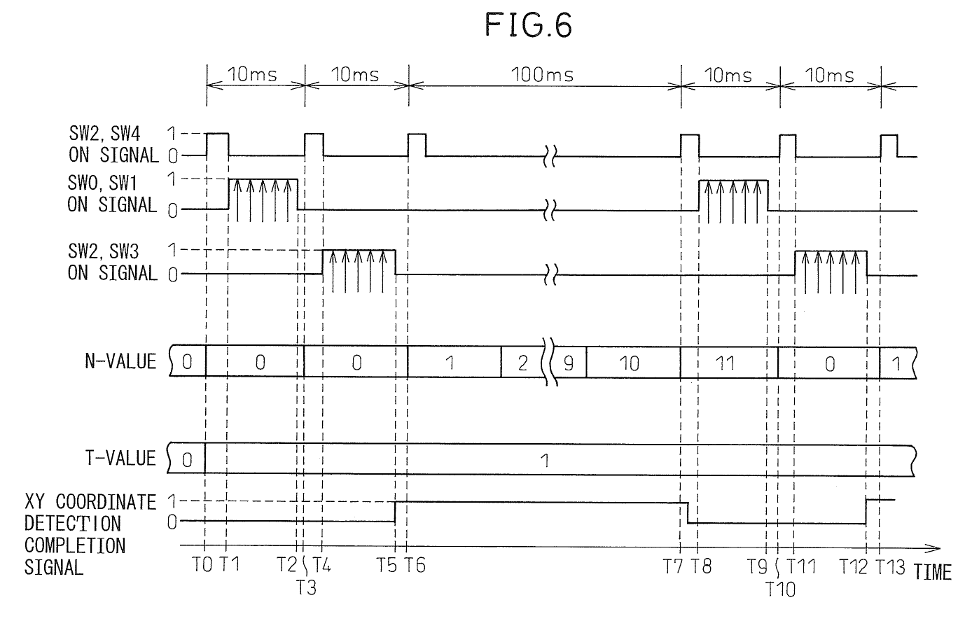

FIG. 6 is a time chart for explaining the coordinate acquisition timing when detecting the X-, Y-coordinates of a touched point on the touch panel in the circuit shown in FIG. 4A and FIG. 5B. This figure shows the ON signals of the switches SW2 and SW4, the ON signals of the switches SW0 and SW1, the ON signals of the switches SW2 and SW3, the N-value (explained later), T-value, and detection end signal of the X-, Y-coordinates. Further, FIG. 6 shows both the state right after the touch panel has been touched and the state where the touch panel is continuously touched.

The ON signals of the switches SW2 and SW4, as explained above, are output every 10 ms (time T0) in the state where the T-value is “0” and two times every 10 ms right after the T-value becomes “1”. Further, the ON signals are output every 100 ms (time T7) in the state where the T-value is “1” and exactly two times every 10 ms right after the ON signals are output. The ON signals of the switches SW0 and SW1 become “1” after the ON signals of the switches SW2 and SW4 every 100 ms (time T1) and become “0” before the next ON signals of the switches SW2 and SW4 become “1” (time T3) (time T2). Further, the ON signals of the switches SW2 and SW3 become “1” after the ON signals of the switches SW0 and SW1 become “0” (time T2) and the ON signals of the switches SW2 and SW4 become “0” (time T4) and become “0” before the next ON signals of the switches SW2 and SW4 become “1” (time T6) (time T5).

Further, during the interval from the time T1 to the time T2 where the ON signals of the switches SW0 and SW1 are “1”, in the predetermined time interval shown by the upward arrows, the potential difference between the Y-electrode terminals YU, YD of the touch panel 10 shown in FIG. 4A is sampled by the microcomputer 8 and the X-coordinate data of the touched position is acquired. Similarly, during the interval from the time T4 to the time T5 where the ON signals of the switches SW2 and SW3 are “1”, in the predetermined time interval shown by the upward arrows, the potential difference between the X-electrode terminals XR, XL of the touch panel 10 shown in FIG. 5A is sampled by the microcomputer 8 and the Y-coordinate data of the touched position is acquired.

When the X-coordinate data and the Y-coordinate data of the touched position are fetched into the microcomputer at the time T5 in this way, the detection end signal of the X-, Y-coordinates becomes “1”. The detection end signal of the X-, Y-coordinates becomes “0” before the next X-coordinate data and Y-coordinate data are fetched into the microcomputer. The value of N determines the cycle of the ON signal of the switch circuit 4 to the touch detection pulse when the touch panel is touched. As shown in this figure, when the maximum value of N is 11, the cycle of the ON signal of the switch circuit 4 to the touch detection pulse can be made 100 ms.

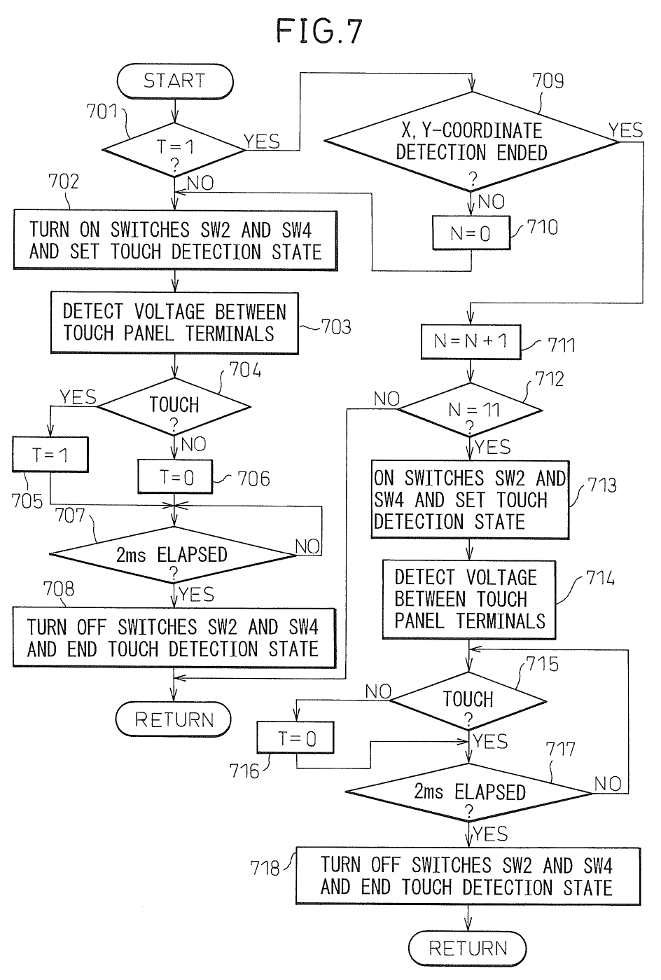

FIG. 7 is a flow chart showing an embodiment of the routine for processing for detection of the existence of a touch of the touch panel in the present invention. This routine is executed every 10 ms for turning the touch detection switches SW2 and SW4 on every 10 ms.

At step 701, whether the touch detection signal T is “1” is judged. First, the time when the touch panel is not touched will be explained. At this time, the touch detection signal T is “0”, so the routine proceeds to step 702 where the switches SW2 and SW4 are turned on to set the touch detection state as explained in FIG. 2.

At step 703, the voltage across the electrode terminals XL, YD of the touch panel is detected by the microcomputer 8. At step 704, whether the touch panel 10 is touched is detected. Further, when touched, at step 705, the touch detection signal T is set to “1”, then the routine proceeds to step 707, while when not touched, at step 706, the touch detection signal T is set to “0” and the routine proceeds to step 707.

At step 707, whether a predetermined time, for example, 2 ms, has elapsed from the start of this processing is judged. Further, when 2 ms has not elapsed, it is waited until 2 ms has elapsed. This 2 ms determines the pulse width of the touch detection pulse. This pulse width is not limited to 2 ms however. Further, when it is judged at step 707 that 2 ms has elapsed, the routine proceeds to step 708, where the switches SW2 and SW4 are turned on to end the touch detection state and this routine is ended. When the touch panel is not touched, the routine from step 701 to step 708 is repeated every 10 ms. When the touch panel is touched, after this routine, the switches SW0 and SW1 are turned on and the X-coordinate data is fetched.

When the routine proceeds to step 701 right after the touch detection signal T is made “1” at step 705, the touch detection signal T is “1”, so the routine proceeds to step 709 where whether the X-, Y-coordinates have finished being detected is judged. This judgment is performed by the X-, Y-coordinate detection end signal explained at FIG. 6.

The X-, Y-coordinate detection end signal, as explained in FIG. 6, remains as “0” when the touch panel is not touched and becomes “1” when the touch panel is touched, then the X-coordinate data and the Y-coordinate data of the touched position are acquired by the microcomputer. Further, the X-, Y-coordinate detection end signal once becomes 1”, then becomes “0” before the time T8 right before when the next X-coordinate data and Y-coordinate data are acquired by the microcomputer.

Accordingly, right after a touch to the touch panel is detected, the touch detection signal T is “0”, so the judgment at step 709 becomes NO, and the routine proceeds to step 710. At step 710, the value of the counter N is made 0 and the routine proceeds to step 702, whereupon the operation from the above-mentioned step 702 to step 708 is repeated and the ON signals of the switches SW2 and SW4 are generated. Further, in the above way, after this routine, the switches SW2 and SW3 become ON and the Y-coordinate data is acquired. As a result, the X-, Y-coordinate detection end signal becomes “1”.

When the Y-coordinate data is acquired and the routine proceeds to step 701, the judgment at step 709 becomes YES, and the routine proceeds to step 711. At step 711, the value of the counter N is increased by exactly “1” and the routine proceeds to step 712. At step 712, whether the count of the counter N has become 11 is judged. When N≦10, the routine ends as is.

On the other hand, when the count of the counter N at step 711 becomes 11, the routine proceeds from step 712 to step 713. At step 713, the switches SW2 and SW4 are turned on to set a touch detection state, at step 714, the voltage between the electrode terminals XL, YD of the touch panel is detected by the microcomputer 8, and at step 715, whether the touch panel 10 has been touched is detected. Further, while the touch continues, the routine proceeds to step 717 as is, while when there is no touch, at step 716, the touch detection signal T is made “0” and the routine proceeds to step 717.

At step 717, in the same way as step 707, it is waited until 2 ms has elapsed. When it is judged at step 717 that 2 ms has elapsed, the routine proceeds to step 718 where the switches SW2 and SW4 are turned off, the touch detection state is ended, and this routine is ended. After this, when the touch to the touch panel continues, the processing from step 709 to step 718 is performed every 10 ms. The routine proceeds from step 712 to step 713 every 100 ms.

In this way, in the above explained embodiment, when the touch panel is not touched, the touch detection processing is performed every 10 ms, while when the touch panel is touched, the touch detection processing is performed every 100 ms.

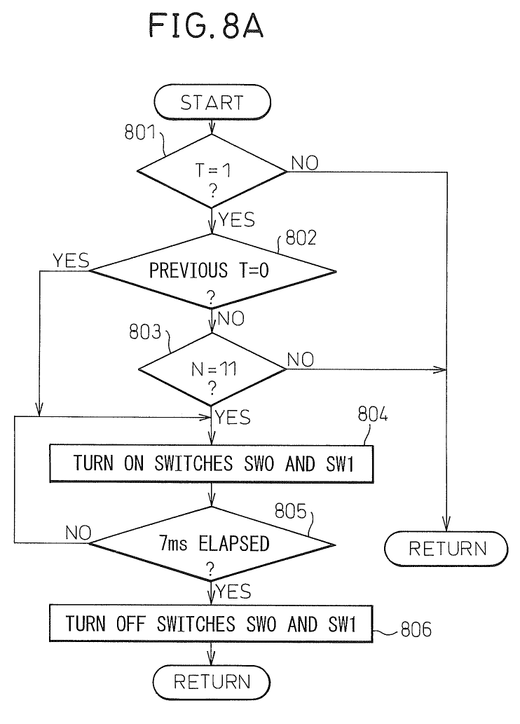

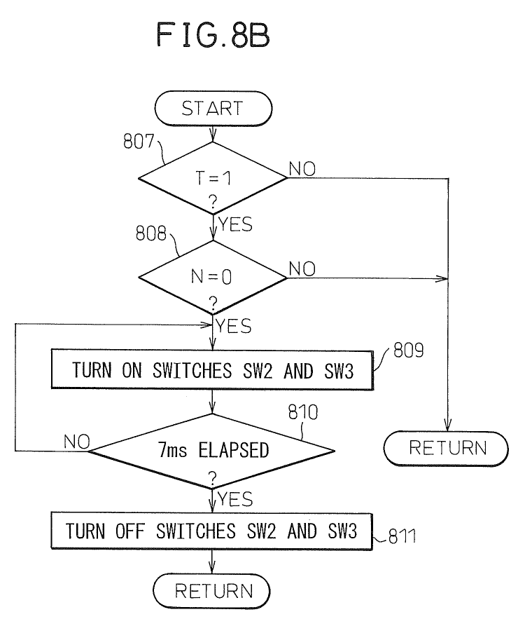

FIG. 8A is a flow chart showing an embodiment of a routine for preparation of detection of an X-coordinate of a position touched on the touch panel in the present invention, while FIG. 8B is a flow chart showing an embodiment of a routine for preparation of detection of a Y-coordinate of a position touched on the touch panel in the present invention. This routine may be executed after the touch detection signal is turned off.

At step 801, whether the touch detection signal T is “1” is detected. When the judgment at step 801 is that the touch detection signal T is “0”, the coordinates do not have to be detected, so this routine is ended. On the other hand, when the judgment at step 801 is that the touch detection signal T is “1”, the routine proceeds to step 802, where whether the touch detection signal T at the previous preparation routine was “1” is detected. When the previous touch detection signal T was “0”, this means the touch panel was touched right before, so the routine proceeds to step 804 where the switches SW0 and SW1 are turned on.

On the other hand, when it was judged at step 802 that the previous touch detection signal T was “1”, at step 803, whether the value of the counter N is 11 is judged. This is because, as shown in FIG. 6, when the value of the counter N is 11, the X-coordinate has to be detected. When the judgment at step 803 is that the value of the counter N is not 11, this routine is ended. When the value of the counter N is 11, the routine proceeds to step 804 where the switches SW0 and SW1 are turned on.

After the switches SW0 and SW1 are turned on at step 804, the routine proceeds to step 805, where whether a predetermined time less than 10 ms for detection of the X-coordinate, for example, 7 ms, has elapsed is judged. Until 7 ms has elapsed, the on states of the switches SW0 and SW1 are continued. When 7 ms has elapsed, the routine proceeds to step 806 where the switches SW0 and SW1 are turned off.

Next, the routine for preparation for detection of the Y-coordinate of FIG. 8B will be explained. At step 807, whether the touch detection signal T is “1” is detected. When the judgment at step 807 is that the touch detection signal T is “0”, there is no need to detect the coordinates, so this routine is ended. On the other hand, when the judgment at step 807 is that the touch detection signal T is “1”, the routine proceeds to step 808, where whether the value of the counter N is 0 is judged. This is because, as shown in FIG. 6, when the value of the counter N is 0, the Y-coordinate has to be detected. When the judgment at step 808 is that the value of the counter N is not 0, this routine is ended, while when the value of the counter N is 0, the routine proceeds to step 809, where the switches SW2 and SW3 are turned on.

At step 809, the switches SW2 and SW3 are turned on, then the routine proceeds to step 810, where whether a predetermined time within 10 ms for detection of the Y-coordinate, for example, 7 ms, has elapsed is judged. Until 7 ms has elapsed, the switches SW2 and SW3 continue to be on. When 7 ms has elapsed, the routine proceeds to step 811, where the switches SW2 and SW3 are turned off.

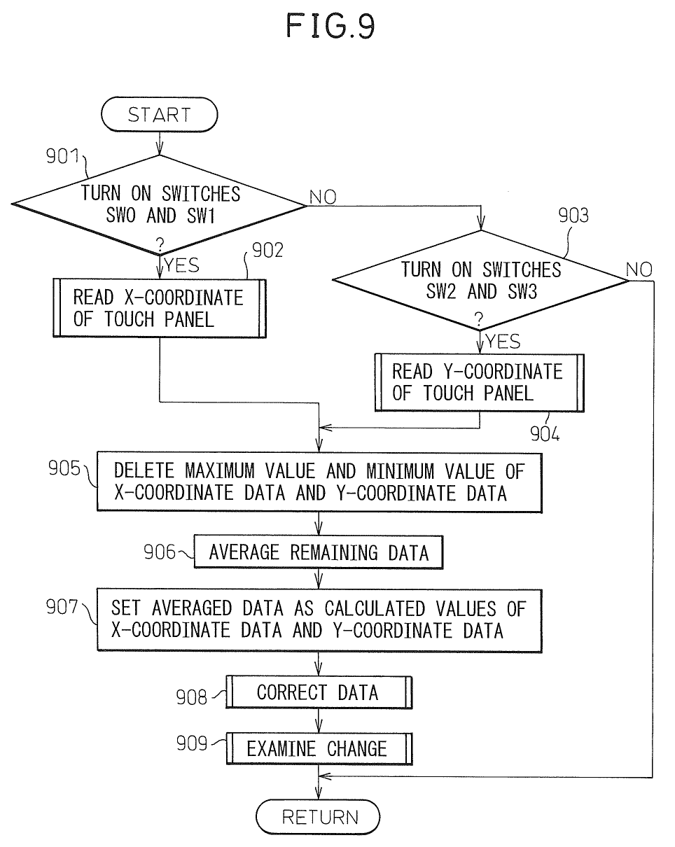

FIG. 9 is a flow chart of an embodiment of a routine for calculation of the X-, Y-coordinates of a position touched by the touch panel in the present invention. In this routine, at step 901, whether the switches SW0 and SW1 are on is judged. Further, when the switches SW0 and SW1 are on, at step 902, the X-coordinate of the touch panel is read and the routine proceeds to step 905. On the other hand, when the switches SW0 and SW1 are not on at step 901, the routine proceeds to step 903, wherein whether the switches SW2 and SW3 are on is judged. Further, when the switches SW2 and SW3 are on, at step 904, the Y-coordinate of the touch panel is read and the routine proceeds to step 905.

At step 905, processing is performed to delete the maximum values and minimum values from the plurality of data of the X-coordinates and the plurality of data of the Y-coordinates read at steps 902 and 903, then at step 906, the remaining data are averaged. Further, at step 907, the averaged data are set as the calculated values of the X-coordinate data and Y-coordinate data. Further, at step 908, the data are corrected, while at step 909, change is examined. Note that the processing from step 905 to step 909 is known processing performed up until now, so will not be explained any further.

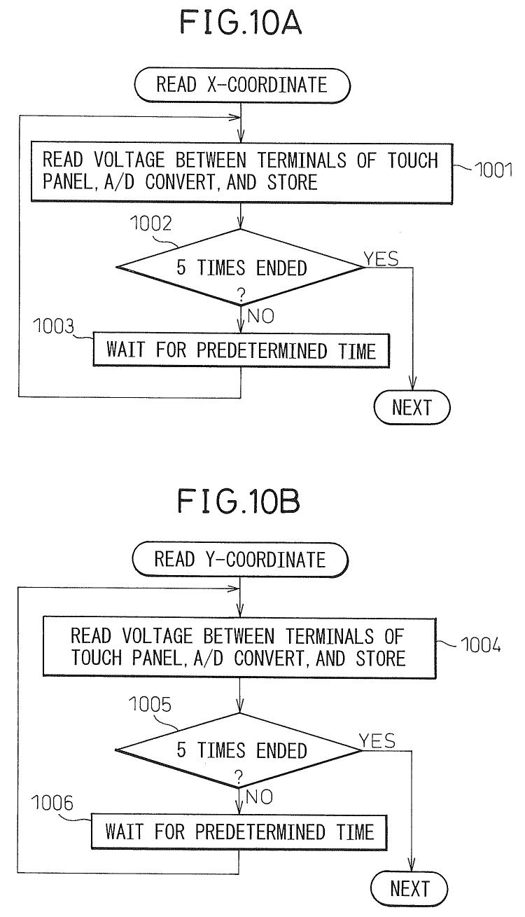

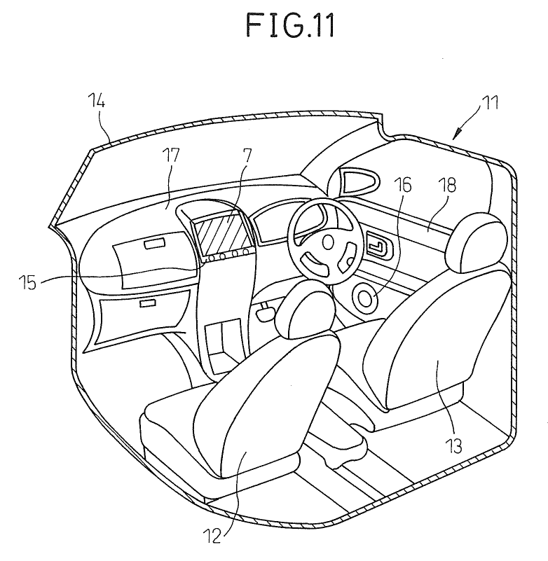

FIG. 10A is a flow chart showing details of step 902 of FIG. 9. In the processing for reading the X-coordinate of the touch panel at step 902, at step 1001, processing is performed to read the voltage between electrode terminals of the touch panel, convert it from an analog to digital value, and store it. Next, at step 1002, whether the read processing at step 1001 was performed five times, that is, whether five bits of data were read, is judged. When five bits of data were read, the routine proceeds to step 905 of FIG. 9, while when five bits of data were still not read, the routine proceeds to step 1003, where a predetermined time (for example, 1 ms) is awaited, then the routine returns to step 1001, where processing is performed to read the voltage between electrode terminals of the touch panel again, convert it from an analog to digital value, and store it.

FIG. 10B is a flow chart showing details of step 904 of FIG. 9. In the processing for reading the Y-coordinate at step 904, at step 1004, processing is performed to read the voltage between electrode terminals of the touch panel, convert it from an analog to digital value, and store it. Next, at step 1005, whether the read processing at step 1004 was performed five times, that is, whether five bits of data were read, is judged. When five bits of data were read, the routine proceeds to step 905 of FIG. 9, while when five bits of data were still not read, the routine proceeds to step 1006, where a predetermined time (for example, 1 ms) is awaited, then the routine returns to step 1004, where processing is performed to read the voltage between electrode terminals of the touch panel again, convert it from an analog to digital value, and store it.

FIG. 11 shows an example of mounting the navigation system 7 provided with a touch panel according to the present invention in a vehicle. In front of the navigator's seat 12 and driver's seat 13 set in the vehicle 11, there is an instrument panel 17 where the navigation system 7 is provided. Beyond that is a front glass 14. Below the navigation system 7 is a control panel 15. Further, speakers 16 are provided inside the front doors 18.

The navigation system 7 provided at the center part of the instrument panel 17 is provided with a touch panel explained in FIG. 1 at its display device. The various operations on the navigation system 7 are performed by a touch panel formed integrally with the surface of the display device 3 of the navigation system 7, a control panel 17, or a not shown infrared or wireless remote controller. The speakers 16 provided at the front door 18 of the vehicle 11 output audio signals from the audio system built in the navigation system 7, sounds corresponding to the images displayed on the display device 3, warning sounds, etc.

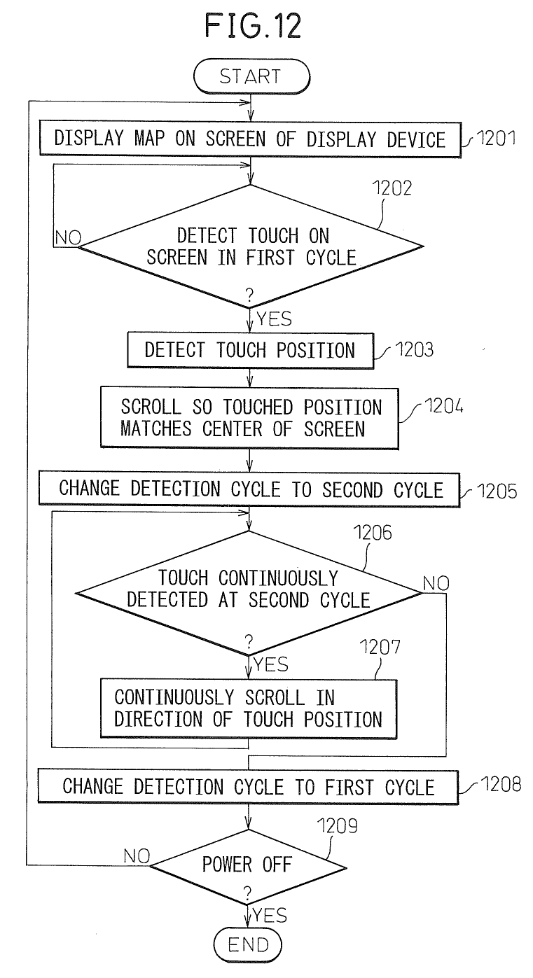

FIG. 12 is a flow chart of an example of the processing for scrolling in the navigation system 7 provided with a touch panel of the present invention. This processing is started when the navigation system 7 is turned on.

When the navigation system 7 is turned on, at step 1201, a map is displayed on the screen of the display device 3. At step 1203, whether the screen (touch panel) of the display device 3 was touched at the first cycle is judged. When no touch to the touch panel is detected, this judgment is continued until a touch is detected.

At step 1202, when a touch to the screen of the display device 3 is detected, the routine proceeds to step 1203, where a touched position is detected. When a touched position to the screen is detected, the routine proceeds to step 1204, where the map is scrolled so that the point of the map right under the touched position matches with the center of the screen. Further, at the next step 1205, the touch detection cycle is changed to a second cycle longer than the first cycle and the routine proceeds to step 1206.

At step 1206, whether the touch to the screen continues in the second cycle as well is judged. When the touch to the screen is judged to continue in the second cycle as well, the routine proceeds to step 1207, where the map is scrolled so that the point of the map right under the touched position continuously matches with the center of the screen. That is, the map in the touched direction continuously appears at the center of the screen. When step 1207 ends, the routine returns to step 1206, where whether the touch continues in the second cycle is judged. So long as the touch continues, the scrolling at step 1207 is repeated.

On the other hand, when the judgment at step 1206 is NO, that is, when the touch is judged not to continue in the second cycle, the routine proceeds to step 1208, where the detection cycle is changed to the first cycle. After this, the routine proceeds to step 1209, where whether the power of the navigation system has been turned off is judged. When the power of the navigation system is off, this routine ends, but when not turned off, the routine returns to step 1201, where the processing form step 1201 to step 1209 is repeated.

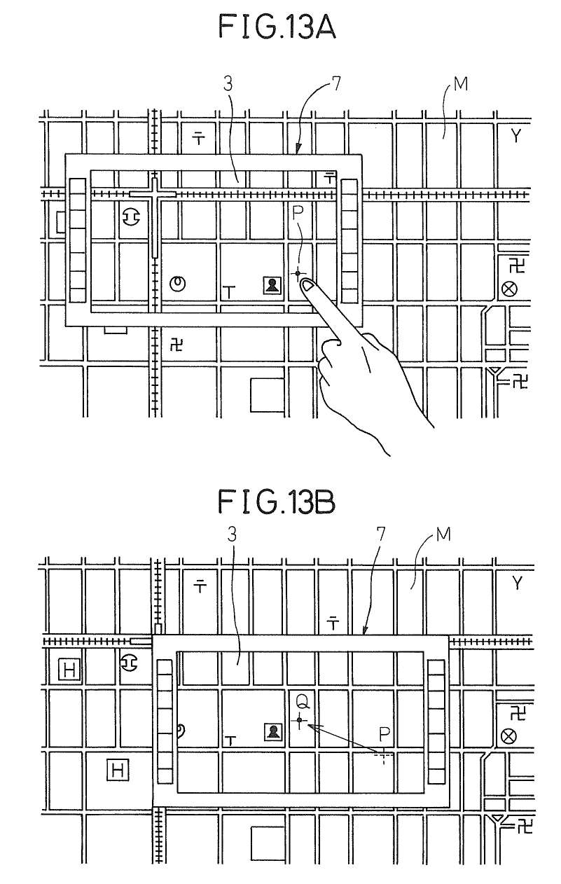

Here, the scrolling for making the touched position match with the center of the screen of the display device will be explained using FIGS. 13A and 13B. As shown in FIG. 13A, the screen of the display device 3 of the navigation system 7 displays part of the map M stored in the navigation system 7. At this time, when the operator of the navigation system 7 touches a point P at the bottom right of the screen, the coordinate position of the touched position P is detected by the detection circuit 5 explained in FIG. 1. The map is scrolled by the navigation system 7 so that the touched position P moves to the center point Q of the screen of the display device 3 as shown in FIG. 13B.

Next, the operation for continuously scrolling the map at the screen of the display device will be explained. As shown in FIG. 13A, when the operator touches the point P at the bottom right of the screen of the display device and continues to touch the point P, the point on the map directly under the point P shown by the broken line of FIG. 13B continuously moves toward the center point Q of the screen. That is, the map M is continuously scrolled from the point P to the point Q direction on the screen of the display device 3 of the navigation system 7.

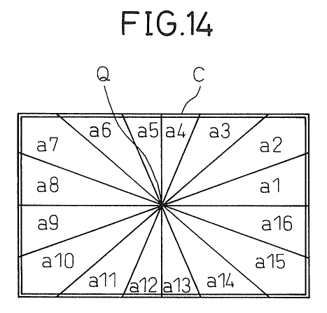

Which direction the map is scrolled by the position touched on the screen of the display device 3 of the navigation system 7 is set in advance. FIG. 14 is a view for explaining this scrolling direction. In this embodiment, as shown in FIG. 14, the screen region C corresponding to the display screen is divided radially into the 16 areas a1 to a16 about the center point Q of the screen. Each area is preset with a range of area and scrolling direction of the map linked together. The number of areas is not limited in this embodiment. The display screen may be divided more finely to increase the number of areas.

As a simple method, it is possible to make the scrolling direction of the areas of the map the same direction (same angle). For example, as one embodiment, the center point Q of the display screen is made the 0 point, the X-axial right direction is made 0°, and a predetermined positive angle is assigned to each area in the counterclockwise direction. In this case, for example, when the area a1 is touched, the point on the map in the area a1 moves toward the region of the area a9 at the position pointed to, so the map on the display device is scrolled in the direction of an angle, for example, 180°, with respect to the X-axis (0°) passing through the center point Q of the screen of the area a9.

Therefore, based on the detected coordinates of the touched position on the screen of the display device 3, which area that position is included in is calculated, then the scrolling direction of the map is determined. Further, the amount of scrolling of the map per touch detection in the case of continuous scrolling (unit dot/touch detection) is preset. When the operator continuously touches the screen, the map is continuously scrolled based on the relationship between the amount of scrolling of the map per touch detection and the determined scrolling direction.

For example, consider the case where the touched position is the point B shown in FIG. 13A and the amount of scrolling of the map per touch detection (20 dots/touch detection). In this case, the touched position P is included in the area a15 of FIG. 14, so the map is continuously scrolled 20 dots at a time in a direction of an angle of 140° from the X-axis of the area a7 point symmetric with the point Q each time a touch is detected in a predetermined detection cycle.

Above, the basic operation of a map display system of the present invention was explained taking as an example a touch panel using a time chart and flow chart. In the embodiment explained above, the cycle for detection of a touch on the touch panel was made 10 ms and the detection cycle of a touch after being touched was made 100 ms, but these numerical values are only examples. The gist of the present invention is to set the cycle for detection of a touch on the touch panel short and set the detection cycle of the touch after being touched several times longer so that both a momentary touch to the touch panel and a scroll operation after the touch panel is touched can be reliably detected.

Note that in the above-mentioned embodiment, an analog resistance type touch panel was explained, but the present invention can of course also be applied to an analog electrostatic capacity type touch panel or a digital optical type touch panel comprised of light emitting elements and light receiving elements arranged in the vertical direction and horizontal direction.

An electrostatic capacity type touch panel is comprised of a transparent conductive substrate made of glass coated on its surface with a substance receiving an electrical signal. When the finger of an operator approaches the glass surface, the electrical signal is detected by a sensor. Therefore, when working the present invention in an electrostatic capacity type touch panel, for example, the detection cycle of the sensor detecting the electrical signal is made short until a touch to the touch panel is detected and the detection cycle is made longer after a touch is detected.

Further, an optical type touch panel is comprised of pairs of light emitting elements, for example, light emitting diodes (LED), and light receiving elements, for example, phototransistors, arranged in the horizontal direction and vertical direction. In an optical type touch panel, the light emitting diodes cyclically successively emit light. If there is a finger or other obstruction when the light from a light emitting diode is received by a phototransistor, the light to the phototransistor is blocked, so the position of the finger is detected by the phototransistor not reached by the light. Therefore, when working the present invention in an optical type touch panel, for example, the cycle of light emission of the light emitting diodes is made short until a touch to the touch panel is detected and the light emission cycle is made longer after a touch is detected.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.)

What is claimed is:

1. A map display device comprising;
a display displaying a map on a screen,
a touch detection circuit detecting a touch operation on the screen in a predetermined detection cycle,
a display control circuit scrolling the map displayed on the screen in response to the detection circuit, and
a detection cycle changing circuit changing the predetermined detection cycle from a first cycle to a second cycle when the touch operation is detected in the first cycle, wherein the second cycle is longer than the first cycle.

2. A map display device as set forth in claim 1, wherein said display control circuit scrolls said map so that a position designated by the touch operation in the first cycle matches with a center of said screen when the touch operation is not detected in said second cycle and continuously scrolls said map so that a position designated by the touch operation in the second cycle moves to the center direction of said screen when the touch operation is detected in the second cycle.

3. A map display device as set forth in claim 1, wherein said detection cycle changing circuit changes the predetermined detection cycle from said second cycle to said first cycle when the touch operation is not detected in said second cycle.

4. A map display device as set forth in claim 2, wherein said detection cycle changing circuit changes the predetermined detection cycle from said second cycle to said first cycle when the touch operation is not detected in said second cycle.

5. A map display device as set forth in claim 1, wherein said detection cycle changing circuit changes the predetermined detection cycle from said first cycle to said second cycle after said touch detection circuit detects the touch operation in said first cycle and calculates a touched position on said screen.

6. A map display device comprising;
a display displaying a map on a screen,
a touch panel comprising a resistance film having a pair of electrode terminals,
a switch circuit applying a signal to detect a touch operation to the electrode terminals in a predetermined cycle,
a detection circuit detecting the touch operation by a value of voltage detected from between the electrode terminals when the signal is applied to the electrode terminals,
a display control circuit scrolling the map displayed on the screen in response to the detection circuit, and
a cycle changing circuit changing the predetermined cycle from a first cycle to a second cycle when the touch operation is detected in the first cycle, wherein the second cycle is longer than the first cycle.

7. A map display method comprising;
displaying a map on a screen,
detecting a touch operation to the screen in a first cycle,
changing the detection cycle from the first cycle to a second cycle when the touch operation is detected in the first cycle, wherein the second cycle is longer than the first cycle,
detecting a touch operation to the screen in the second cycle, and
controlling the scrolling of the map displayed on the screen in response to the touch operation.

8. A map display method as set forth in claim 7, further comprising scrolling said map so that a position designated by the touch operation in the first cycle matches a center of said screen when the detection cycle is changed from said first cycle to said second cycle, then the touch operation is not detected in said second cycle and continuously scrolling said map so that a position designated by the touch operation in the second cycle moves to the center direction of said screen when the touch operation is detected in said second cycle.

9. A map display method as set forth in claim 8, further comprising changing the detection cycle from said second cycle to said first cycle when the touch operation is not detected in said second cycle.
